(19) United States
(12) Patent Application Publication
(10) Pub. No.: US 2023/0241821 A1
(43) Pub. Date: Aug. 3, 2023

(54) INJECTION MOLDING APPARATUS AND INJECTION MOLDING METHOD

(71) Applicant: Kabushiki Kaisha Toshiba, Tokyo (JP)

(72) Inventors: Satoshi SAYAMA, Yokohama Kanagawa (JP); Yuko IIZUKA, Yokohama Kanagawa (JP)

(21) Appl. No.: 17/819,859

(22) Filed: Aug. 15, 2022

(30) Foreign Application Priority Data
Feb. 3, 2022 (JP) 2022-015403

(51) Int. Cl. B29C 45/56; B29C 45/33; B29C 45/72

(52) U.S. Cl. CPC B29C 45/561; B29C 45/33; B29C 45/7207; B29C 2045/563

(57) ABSTRACT

An injection molding apparatus according to an embodiment is configured to mold a thermoplastic resin into a thick-walled component by injection molding. The injection molding apparatus includes a mold having a cavity and a core; and a controller configured to control an operation of the mold. The controller is capable of performing a filling and pressure holding process of filling the thermoplastic resin between the cavity and the core in a state in which a distance between the cavity and the core is increased, and a cooling and solidifying process of cooling and solidifying the filled thermoplastic resin while pressurizing the filled thermoplastic resin by decreasing the distance between the cavity and the core. The controller stacks the thermoplastic resin by performing an operation set including the filling and pressure holding process and the cooling and solidifying process a plurality of times.

### CROSS-REFERENCE TO RELATED APPLICATIONS

This application is based upon and claims the benefit of priority from Japanese Patent Application No. 2022-015403, filed on Feb. 3, 2022; the entire contents of which are incorporated herein by reference.

### FIELD

Embodiments of the invention generally relate to an injection molding apparatus and an injection molding method.

### BACKGROUND

In an injection molding apparatus or an injection molding method for molding a thermoplastic resin by injection molding, for example, when a thick-walled component having a thickness of about 50 mm is molded, sink marks may occur on a surface of a molded product or voids may occur inside the molded product due to a decrease in volume when the resin is solidified. In the injection molding apparatus and the injection molding method, it is required to prevent occurrence of the sink marks and the voids when the thick-walled component is molded.

### BRIEF DESCRIPTION OF THE DRAWINGS

FIG. 1 is a view schematically showing an injection molding apparatus according to a first embodiment;

FIG. 2A and FIG. 2B are a plan view and a cross-sectional view schematically showing an example of the first contact member of the injection molding apparatus according to the first embodiment;

FIG. 3A and FIG. 3B are a plan view and a cross-sectional view schematically showing an example of the second contact member of the injection molding apparatus according to the first embodiment;

FIG. 4 is a plan view schematically showing another example of the first contact member of the injection molding apparatus according to the first embodiment;

FIG. 5A and FIG. 5B are views showing operations of the injection molding apparatus according to the first embodiment;

FIG. 6A and FIG. 6B are views showing operations of the injection molding apparatus according to the first embodiment;

FIG. 7A and FIG. 7B are views showing operations of the injection molding apparatus according to the first embodiment;

FIG. 8A and FIG. 8B are views showing operations of the injection molding apparatus according to the first embodiment;

FIG. 9 is a flowchart showing an example of an injection molding method according to the first embodiment; and

FIG. 10 is a view schematically showing an injection molding apparatus according to a second embodiment.

### DETAILED DESCRIPTION

An injection molding apparatus according to an embodiment is an apparatus that molds a thermoplastic resin into a thick-walled component by injection molding, and includes a mold having a cavity and a core, and a controller that controls an operation of the mold. The controller can perform a filling and pressure holding process of filling the thermoplastic resin between the cavity and the core in a state in which a distance between the cavity and the core is increased, and a cooling and solidifying process of cooling and solidifying the filled thermoplastic resin while pressurizing the filled thermoplastic resin by decreasing the distance between the cavity and the core. The controller stacks the thermoplastic resin by performing an operation set including the filling and pressure holding process and the cooling and solidifying process multiple times.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

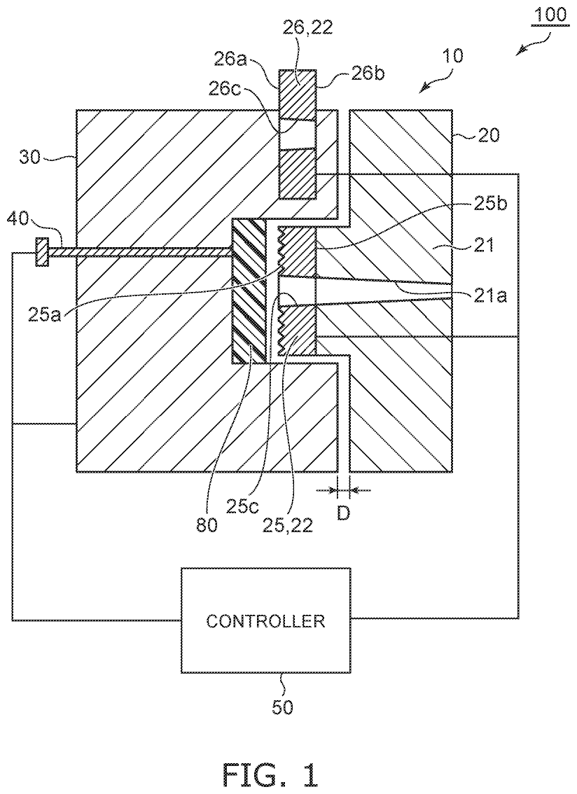

FIG. 1 is a view schematically showing an injection molding apparatus according to a first embodiment.

As shown in FIG. 1, an injection molding apparatus 100 according to the first embodiment includes a mold 10 and a controller 50. The injection molding apparatus 100 is an apparatus that molds a thermoplastic resin 80 into a thick-walled component by injection molding.

The mold 10 includes a cavity 20, a core 30, and an ejector pin 40. The cavity 20 is a member on a fixed side of the mold 10. The core 30 is a member on a movable side of the mold 10. In the example, the cavity 20 has a convex portion, and the core 30 has a concave portion. In a state in which the mold 10 is closed (that is, a state in which a distance D between the cavity 20 and the core 30 is minimum), the convex portion of the cavity 20 is positioned inside the concave portion of the core 30.

The cavity 20 includes a body portion 21 and a contact member 22. The body portion 21 is provided with a runner 21a that fills the thermoplastic resin. In the example, the runner 21a penetrates the inside of the body portion 21 from a surface of the body portion 21 on a side opposite the core 30 to a surface of the body portion 21 on a core 30 side. In the example, the runner 21a is a hot runner. The runner 21a includes, for example, an openable and closable valve gate.

The contact member 22 is attached to the body portion 21 between the body portion 21 and the core 30. The contact member 22 is provided at a tip end of the convex portion of the cavity 20, and is in contact with the thermoplastic resin filled in the mold 10.

In the example, a first contact member 25 and a second contact member 26 are provided as the contact member 22. The cavity 20 is used in a state in which one of the first contact member 25 and the second contact member 26 is attached to a position at which the one of the first contact member 25 and the second contact member 26 is in contact with the thermoplastic resin 80. The first contact member 25 and the second contact member 26 will be described later.

The ejector pin 40 is provided in the core 30. The ejector pin 40 moves toward a cavity 20 side, thereby causing the solidified thermoplastic resin 80 (that is, a molded product) to protrude toward the cavity 20 side.

The controller 50 controls an operation of the mold 10. More specifically, the controller 50 changes the distance between the cavity 20 and the core 30 by allowing the core 30 to move with respect to the cavity 20. In addition, the controller 50 replaces the first contact member 25 with the second contact member 26. In addition, the controller 50 allows the ejector pin 40 to operate to cause the solidified thermoplastic resin 80 to protrude toward the cavity 20 side. Control by the controller 50 will be described later.

Hereinafter, the first contact member 25 and the second contact member 26 will be described in more detail.

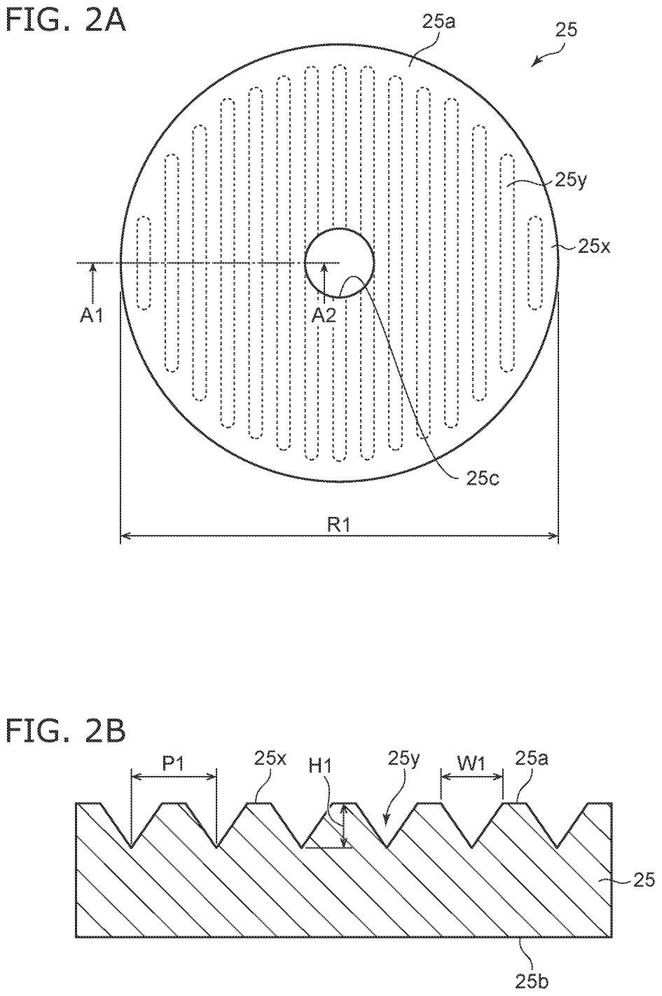

FIG. 2A and FIG. 2B are a plan view and a cross-sectional view schematically showing an example of the first contact member of the injection molding apparatus according to the first embodiment.

As shown in FIG. 2A and FIG. 2B, the first contact member 25 includes a first surface 25a, a second surface 25b, and a first gate hole 25c.

In a state in which the first contact member 25 is attached to the body portion 21, the first surface 25a faces the core 30 and is in contact with the thermoplastic resin 80. The second surface 25b faces a side opposite the first surface 25a. In a state in which the first contact member 25 is attached to the body portion 21, the second surface 25b faces the body portion 21 and is in contact with the body portion 21.

The first surface 25a of the first contact member 25 includes a flat surface portion 25x and grooves 25y. The flat surface portion 25x is, for example, parallel to the second surface 25b. The grooves 25y are concave portions recessed from the flat surface portion 25x toward the second surface 25b. The grooves 25y are, for example, concave portions having a V-shaped cross section.

A width W1 of each groove 25y is favorably 10% or more and 20% or less of a thickness of the solidified thermoplastic resin stacked in one operation set. The width W1 of the groove 25y is favorably 10 mm or less. A depth H1 of the groove 25y is favorably 10% or more and 20% or less of the thickness of the solidified thermoplastic resin stacked in one operation set. The depth H1 of the groove 25y is favorably 10 mm or less. A pitch width P1 of grooves 25y is favorably 5% or more and 10% or less of an outer diameter R1 of the first surface 25a. The pitch width P1 of the grooves 25y is favorably 10 mm or less.

In the example, multiple grooves 25y extending in the same direction are provided in the first surface 25a. In the example, multiple grooves 25y provided in the first surface 25a do not intersect each other.

The first gate hole 25c penetrates the inside of the first contact member 25 from the second surface 25b to the first surface 25a. The first gate hole 25c is provided at a position where the first gate hole 25c communicates with the runner 21a of the body portion 21 in a state in which the first contact member 25 is attached to the body portion 21. In a state in which the first contact member 25 is attached to the body portion 21, the thermoplastic resin supplied from the runner 21a is supplied to a space between the first contact member 25 and the core 30 through the first gate hole 25c.

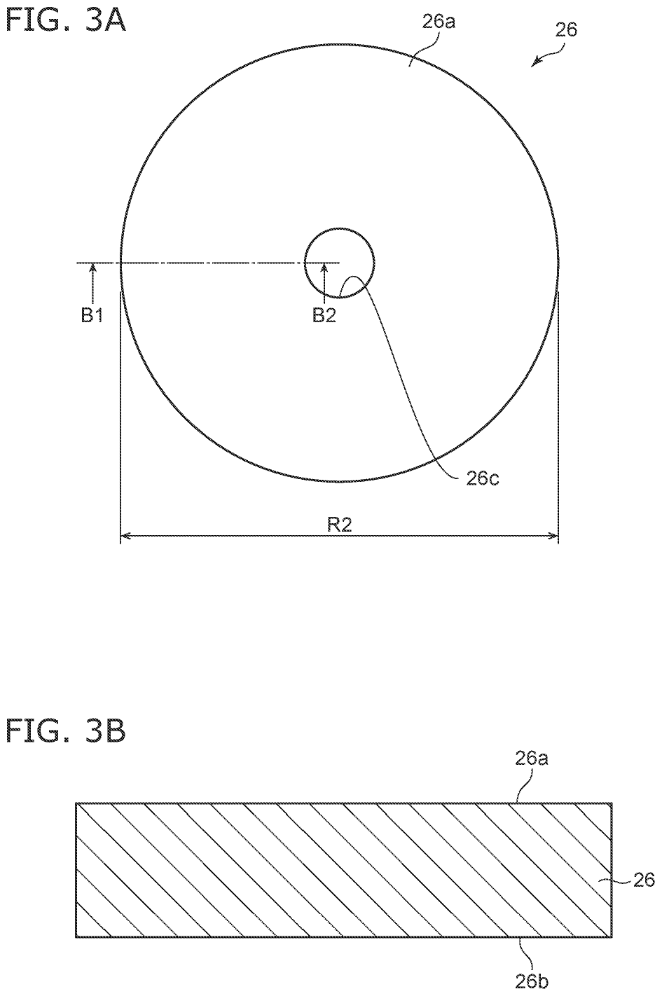

FIG. 3A and FIG. 3B are a plan view and a cross-sectional view schematically showing an example of the second contact member of the injection molding apparatus according to the first embodiment.

As shown in FIG. 3A and FIG. 3B, the second contact member 26 includes a third surface 26a, a fourth surface 26b, and a second gate hole 26c.

In a state in which the second contact member 26 is attached to the body portion 21, the third surface 26a faces the core 30 and is in contact with the thermoplastic resin. The fourth surface 26b faces a side opposite the third surface 26a. In a state in which the second contact member 26 is attached to the body portion 21, the fourth surface 26b faces the body portion 21 and is in contact with the body portion 21.

The third surface 26a of the second contact member 26 is, for example, parallel to the fourth surface 26b. That is, no groove is provided in the third surface 26a. An outer diameter R2 of the third surface 26a is, for example, the same as the outer diameter R1 of the first surface 25a.

The second gate hole 26c penetrates the inside of the second contact member 26 from the fourth surface 26b to the third surface 26a. The second gate hole 26c is provided at a position where the second gate hole 26c communicates with the runner 21a of the body portion 21 in a state in which the second contact member 26 is attached to the body portion 21. In a state in which the second contact member 26 is attached to the body portion 21, the thermoplastic resin supplied from the runner 21a is supplied to a space between the second contact member 26 and the core 30 through the second gate hole 26c.

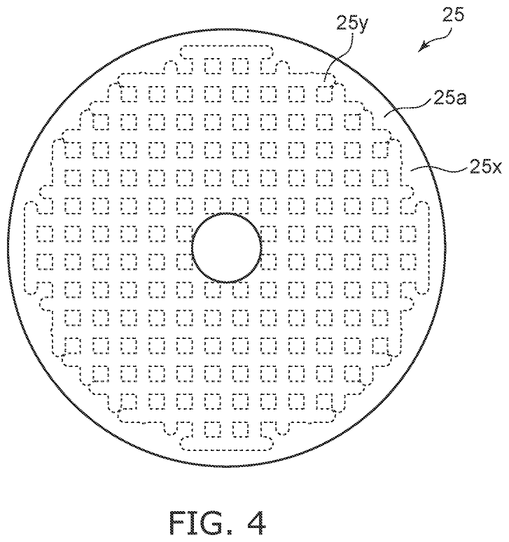

FIG. 4 is a plan view schematically showing another example of the first contact member of the injection molding apparatus according to the first embodiment.

As shown in FIG. 4, multiple grooves 25y extending in different directions may be provided in the first surface 25a of the first contact member 25. In the example, multiple grooves 25y extending in a vertical direction and multiple grooves 25y extending in a lateral direction are provided. The vertical direction and the lateral direction are orthogonal to each other. Thus, multiple grooves 25y provided in the first surface 25a may intersect each other.

In FIGS. 2A, 2B, and 4, a case where the grooves 25y having a linear shape in a plan view are provided is described as an example, but in the embodiment, for example, the grooves 25y having a curved shape in a plan view may also be provided. In such a case, the grooves 25y in a plan view may have, for example, a concentric circular shape, a spiral shape, or the like.

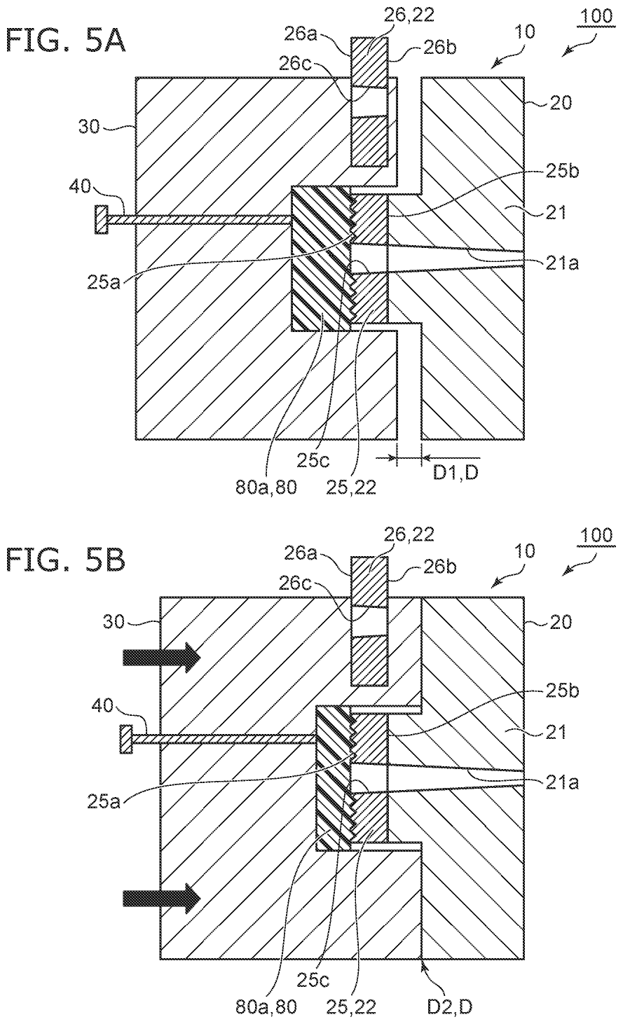

FIGS. 5A to 8B are views showing operations of the injection molding apparatus according to the first embodiment.

As shown in FIGS. 5A to 8B, the controller 50 can perform the filling and pressure holding process and the cooling and solidifying process. The cooling and solidifying process is performed after the filling and pressure holding process.

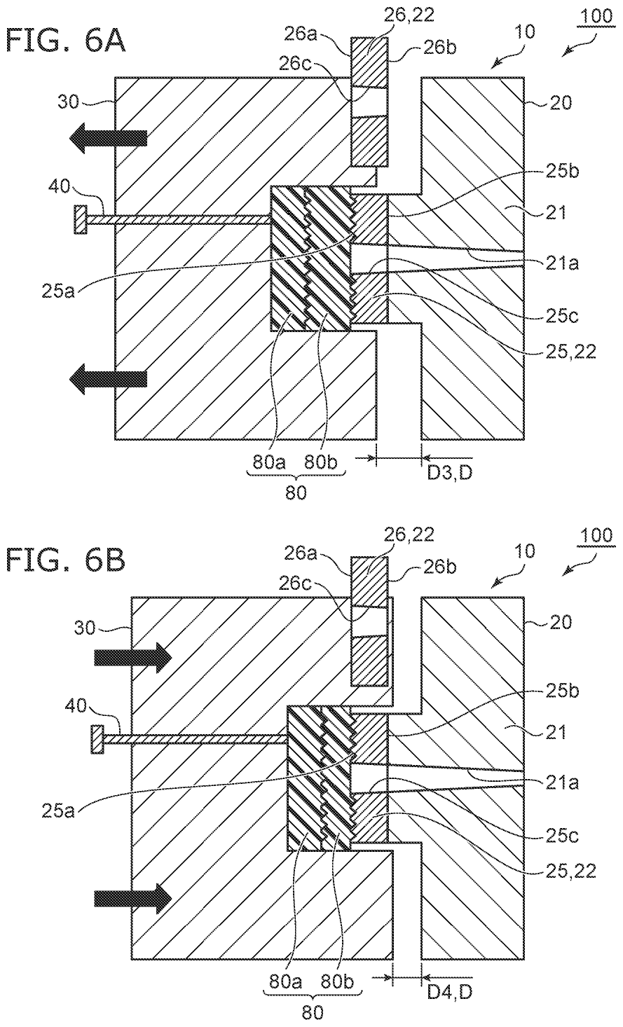

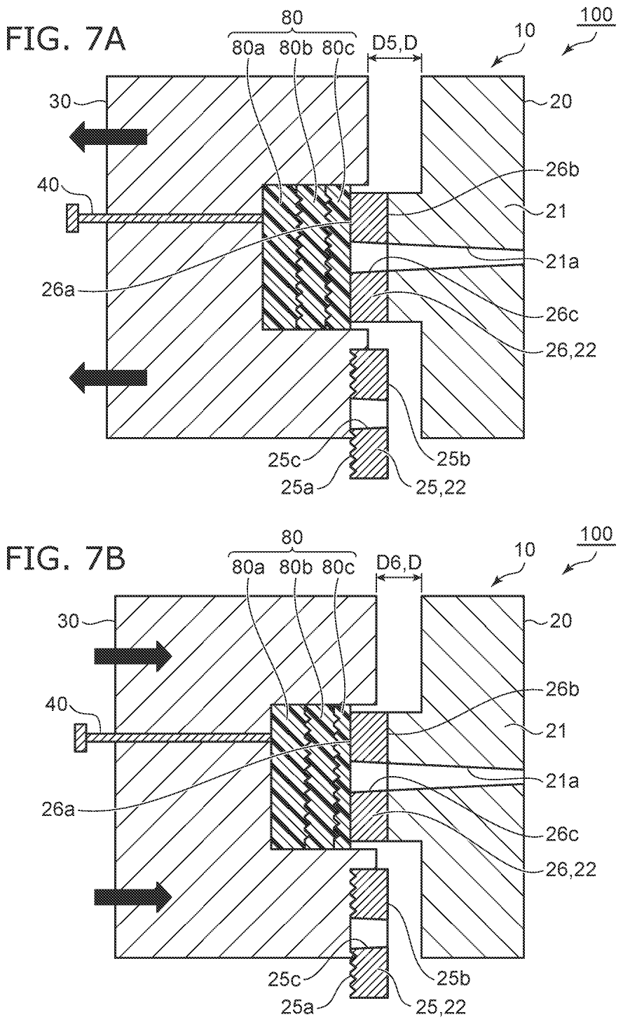

In the filling and pressure holding process, the controller 50 fills the thermoplastic resin 80 between the cavity 20 and the core 30 in a state in which the distance D between the cavity 20 and the core 30 is increased. FIG. 5A, FIG. 6A, and FIG. 7A each show the filling and pressure holding process. In the cooling and solidifying process, the controller 50 cools and solidifies the filled thermoplastic resin 80 while pressurizing the filled thermoplastic resin 80 by decreasing the distance D between the cavity 20 and the core 30. FIG. 5B, FIG. 6B, and FIG. 7B each show the cooling and solidifying process.

The controller 50 stacks the thermoplastic resin by performing the operation set including the filling and pressure holding process and the cooling and solidifying process multiple times. One operation set includes performing the filling and pressure holding process and the cooling and solidifying process once, respectively. By performing one operation set, one layer of thermoplastic resin is stacked.

For example, the controller 50 stacks the thermoplastic resin N times by performing N times of the operation set. N is an integer of 2 or more. N is, for example, 2 or more and 10 or less. In the following example, a case where N is 3 will be described as an example, but N is not limited to 3. FIG. 5A and FIG. 5B show a first operation set. FIG. 6A and FIG. 6B show a second operation set. FIG. 7A and FIG. 7B show a third operation set.

As shown in FIG. 5A and FIG. 5B, the first operation set is performed in a state in which the first contact member 25 is attached to the body portion 21. As shown in FIG. 5A, in a filling and pressure holding process of the first operation set, the thermoplastic resin 80 is filled between the cavity 20 and the core 30 in a state in which the distance D between the cavity 20 and the core 30 is increased to a first distance D1 (that is, in a state in which the core 30 is separated from the cavity 20). Hereinafter, the thermoplastic resin 80 filled in a first filling and pressure holding process is referred to as a thermoplastic resin 80a.

As shown in FIG. 5B, in a cooling and solidifying process of the first operation set, the distance D between the cavity 20 and the core 30 is decreased to a second distance D2 (that is, the core 30 is brought close to the cavity 20), thereby cooling and solidifying the filled thermoplastic resin 80a while pressurizing the filled thermoplastic resin 80a. In the example, the second distance D2 is 0. That is, in the example, the cavity 20 and the core 30 are in contact with each other in the cooling and solidifying process of the first operation set. The cavity 20 and the core 30 may also not be in contact with each other. The second distance D2 may be smaller than the first distance D1 and may not be 0.

As shown in FIG. 6A and FIG. 6B, the second operation set is performed in a state in which the first contact member 25 is attached to the body portion 21. As shown in FIG. 6A, in a filling and pressure holding process of the second operation set, the thermoplastic resin 80 is filled between the cavity 20 and the core 30 (the thermoplastic resin 80a) in a state in which the distance D between the cavity 20 and the core 30 is increased to a third distance D3 (that is, in a state in which the core 30 is separated from the cavity 20). Hereinafter, the thermoplastic resin 80 filled in a second filling and pressure holding process is referred to as a thermoplastic resin 80b.

As shown in FIG. 6B, in a cooling and solidifying process of the second operation set, the distance D between the cavity 20 and the core 30 is decreased to a fourth distance D4 (that is, the core 30 is brought close to the cavity 20), thereby cooling and solidifying the filled thermoplastic resin 80b while pressurizing the filled thermoplastic resin 80b. The fourth distance D4 is smaller than the third distance D3.

As shown in FIG. 7A and FIG. 7B, the third operation set is performed in a state in which the second contact member 26 is attached to the body portion 21. As shown in FIG. 7A, in a filling and pressure holding process of the third operation set, the thermoplastic resin 80 is filled between the cavity 20 and the core 30 (the thermoplastic resin 80b) in a state in which the distance D between the cavity 20 and the core 30 is increased to a fifth distance D5 (that is, in a state in which the core 30 is separated from the cavity 20). Hereinafter, the thermoplastic resin 80 filled in a third filling and pressure holding process is referred to as a thermoplastic resin 80c.

As shown in FIG. 7B, in a cooling and solidifying process of the third operation set, the distance D between the cavity 20 and the core 30 is decreased to a sixth distance D6 (that is, the core 30 is brought close to the cavity 20), thereby cooling and solidifying the filled thermoplastic resin 80c while pressurizing the filled thermoplastic resin 80c. The sixth distance D6 is smaller than the fifth distance D5.

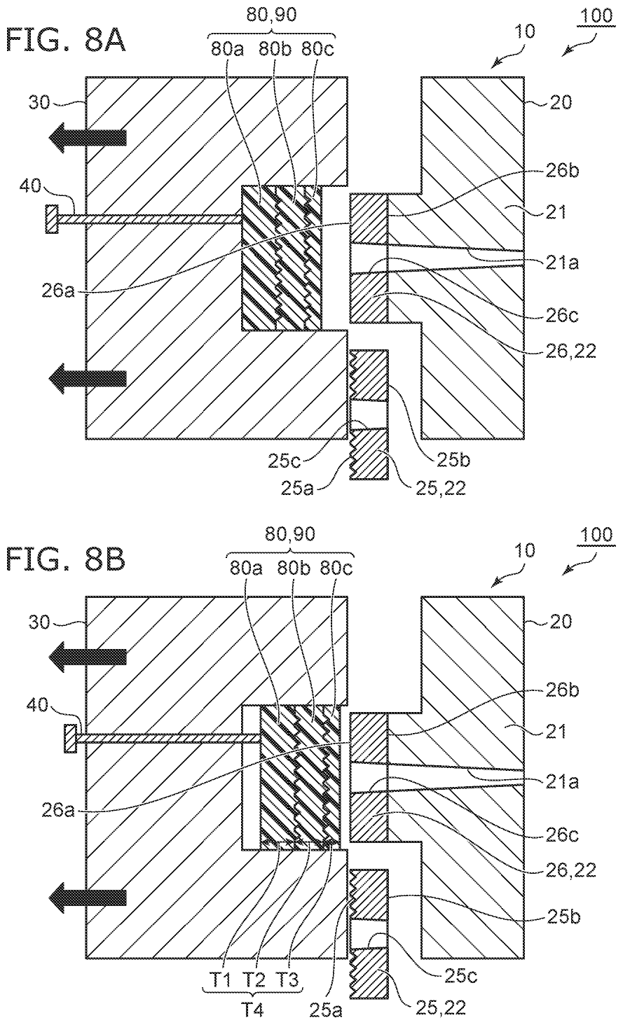

As shown in FIG. 8A and FIG. 8B, once the third operation set is completed, the ejector pin 40 is allowed to operate in a state in which the distance D between the cavity 20 and the core 30 is increased (that is, in a state in which the core 30 is separated from the cavity 20), thereby causing the solidified thermoplastic resin 80 to protrude toward the cavity 20 side.

Accordingly, a thick-walled component (molded product) 90 in which the thermoplastic resin 80a, the thermoplastic resin 80b, and the thermoplastic resin 80c are stacked is manufactured. In the example, a thickness T4 of the thick-walled component (molded product) 90 is 50 mm. A thickness T1 of the solidified thermoplastic resin 80a is 20 mm. A thickness T2 of the solidified thermoplastic resin 80b is 20 mm. A thickness T3 of the solidified thermoplastic resin 80c is 10 mm. A thickness of the solidified thermoplastic resin 80 that is stacked in each operation set can be set to any value. The thickness of the solidified thermoplastic resin that is stacked in one operation set is favorably 5 mm or more and 20 mm or less.

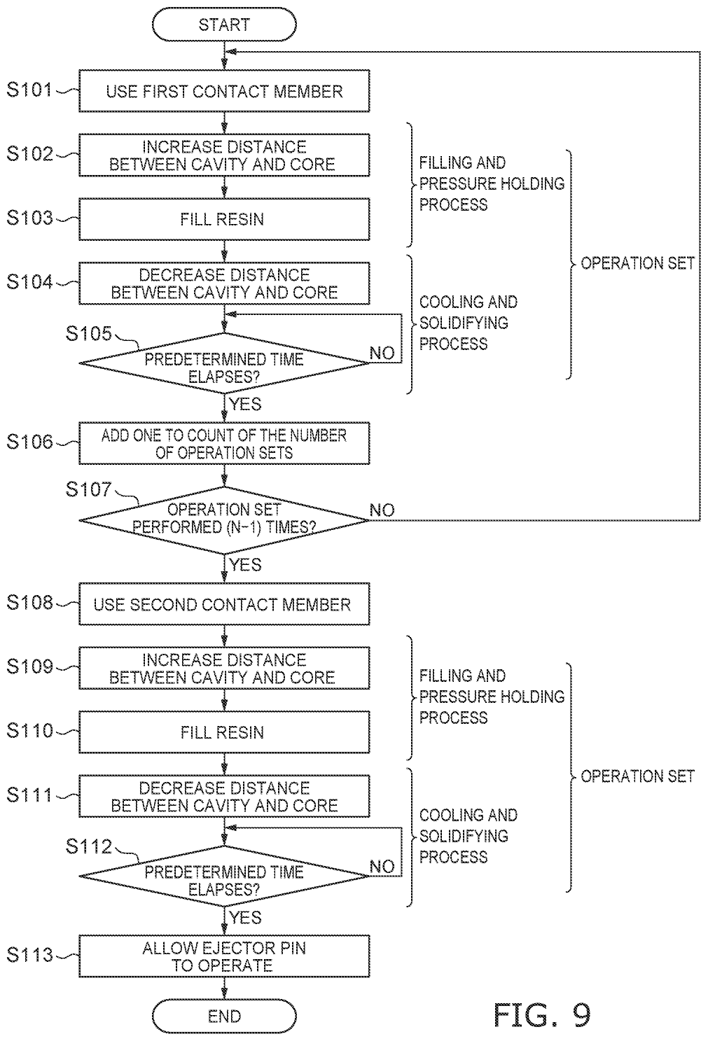

FIG. 9 is a flowchart showing an example of an injection molding method according to the first embodiment.

As shown in FIG. 9, the controller 50 starts an operation set using the first contact member 25 (step S101).

When the operation set is started, the controller 50 performs a filling and pressure holding process. In the filling and pressure holding process, the controller 50 increases the distance D between the cavity 20 and the core 30 (step S102). In the filling and pressure holding process, the controller then fills the thermoplastic resin 80 between the cavity 20 and the core 30 in a state in which the distance D between the cavity 20 and the core 30 is increased (step S103).

Next, the controller 50 performs a cooling and solidifying process. In the cooling and solidifying process, the controller 50 decreases the distance D between the cavity 20 and the core 30 (step S104). Accordingly, the filled thermoplastic resin is pressurized between the cavity 20 and the core 30. In the cooling and solidifying process, the controller 50 then maintains a state (that is, a pressurized state) in which the distance D between the cavity 20 and the core 30 is decreased until a predetermined time elapses (step S105: No). The predetermined time is, for example, 5 minutes or more and 10 minutes or less.

When the predetermined time elapses (step S105: Yes), the controller 50 adds one to a count of the number of operation sets (step S106). Next, the controller 50 determines whether the number of performed operation sets reaches (N−1) times (step S107). When the number of performed operation sets does not reach (N−1) times (step S107: No), the controller 50 returns to step S101.

The controller 50 repeats operations of using the first contact member 25 (step 101), performing the operation set (steps S102 to S105), adding one to the count of the number of operation sets (step S106), and determining the number of performed operation sets (step S107) until the number of performed operation sets reaches (N−1) times.

When the number of performed operation sets reaches (N−1) times (step S107: Yes), the controller 50 uses the second contact member 26 (step S108). That is, before a last operation set, the controller 50 switches the first contact member 25 to the second contact member 26. The controller 50 performs an operation set (steps S109 to S112) in the same manner as the operation set (steps S102 to S105) when the first contact member 25 is used.

When the operation set using the second contact member 26 is completed, the controller 50 allows the ejector pin 40 to operate (step S113) and ends the injection molding.

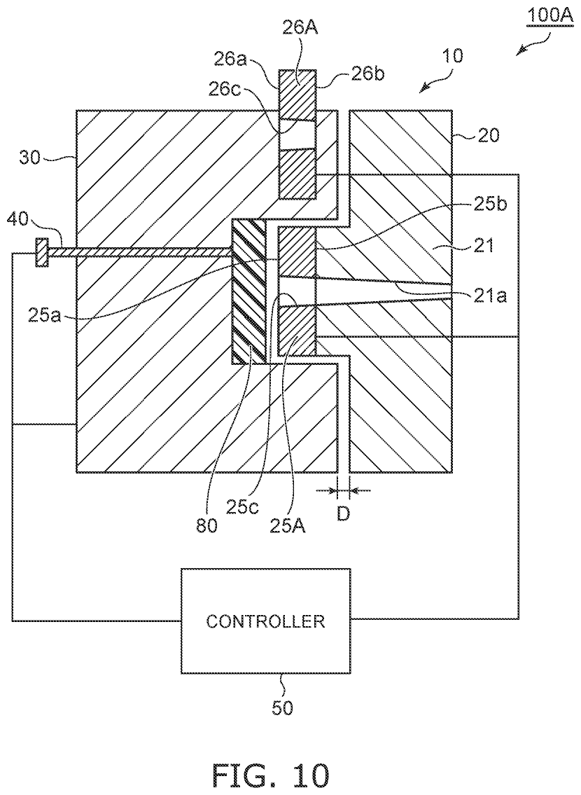

FIG. 10 is a view schematically showing an injection molding apparatus according to a second embodiment.

As shown in FIG. 10, an injection molding apparatus 100A according to the second embodiment is substantially the same as the injection molding apparatus 100 according to the first embodiment except that a first contact member 25A and a second contact member 26A are used instead of the first contact member 25 and the second contact member 26.

The first contact member 25A and the second contact member 26A are not provided with grooves. A first surface 25a of the first contact member 25A is heated to a temperature higher than that of the core 30 in a cooling and solidifying process. A third surface 26a of the second contact member 26A is heated to a temperature lower than that of the first contact member 25A in the cooling and solidifying process. The third surface 26a of the second contact member 26A is heated to, for example, the same temperature as that of the core 30 in the cooling and solidifying process.

In the example, when an operation set is performed N times, the controller 50 uses the first contact member 25A in first to (N−1)-th operation sets, and uses the second contact member 26A in an N-th operation set. That is, the controller 50 switches from the first contact member 25A to the second contact member 26A when a last operation set is performed. Otherwise, in the same manner as the injection molding apparatus 100 and the injection molding method according to the first embodiment described above, a thermoplastic resin can be molded into a thick-walled component by stacking the thermoplastic resin by performing the operation set including a filling and pressure holding process and the cooling and solidifying process multiple times.

Hereinafter, functions and effects of an injection molding apparatus and an injection molding method according to the embodiments will be described.

In the injection molding apparatus or the injection molding method for molding a thermoplastic resin by injection molding, for example, when a thick-walled component having a thickness of 50 mm or more is molded, sink marks may occur on a surface of a molded product or voids may occur inside the molded product due to a decrease in volume when the resin is solidified. In the injection molding apparatus or the injection molding method, it is required to prevent occurrence of the sink marks and the voids when the thick-walled component is molded.

On the other hand, according to the injection molding apparatus according to the embodiments, when the thermoplastic resin 80 is molded into the thick-walled component by stacking the thermoplastic resin 80 by performing an operation set including a filling and pressure holding process and a cooling and solidifying process multiple times, it is possible to prevent the occurrence of the sink marks and the voids. In addition, in the cooling and solidifying process, the occurrence of the sink marks and the voids can be further prevented by decreasing a distance between the cavity 20 and the core 30 and cooling and solidifying the filled thermoplastic resin 80 while pressurizing the filled thermoplastic resin 80.

In addition, by using the cavity 20 including the first contact member 25 whose surface (a first surface 25a) in contact with the thermoplastic resin 80 is provided with the grooves 25y, it is possible to easily melt a portion in contact with the first contact member 25 in the thermoplastic resin 80 solidified in the mold 10. Accordingly, adhesiveness between a layer of the thermoplastic resin 80 solidified in the mold 10 and a layer of a newly filled thermoplastic resin 80 can be improved.

When the operation set is performed N times, the first contact member 25 provided with the grooves 25y is used in first to (N−1)-th operation sets, and the second contact member 26 not provided with the grooves 25y is used in an N-th operation set, so that a surface of the thick-walled component on a cavity 20 side can be brought into the same state as other surfaces of the thick-walled component (for example, into a plan surface shape) while improving the adhesiveness between the layer of the thermoplastic resin 80 solidified in the mold 10 and the layer of the newly filled thermoplastic resin 80.

In addition, by using the cavity 20 including the first contact member 25A whose surface (a first surface 25a) in contact with the thermoplastic resin 80 is heated to a temperature higher than that of the core 30, it is possible to easily melt a portion in contact with the first contact member 25A in the thermoplastic resin 80 solidified in the mold 10. Accordingly, the adhesiveness between the layer of the thermoplastic resin 80 solidified in the mold 10 and the layer of the newly filled thermoplastic resin 80 can be improved.

When the operation set is performed N times, the first contact member 25A whose surface (the first surface 25a) in contact with the thermoplastic resin 80 is heated to a temperature higher than that of the core 30 is used in the first to (N−1)-th operation sets, and the second contact member 26A whose surface (the third surface 26a) in contact with the thermoplastic resin 80 is heated to a temperature lower than that of the first contact member 25A is used in the N-th operation set, so that the surface of the thick-walled component on the cavity 20 side can be brought into the same state as other surfaces of the thick-walled component while improving the adhesiveness between the layer of the thermoplastic resin 80 solidified in the mold 10 and the layer of the newly filled thermoplastic resin 80.

When the operation set is performed N times, an ejector pin is not allowed to operate during the first to N-th operation sets, and the ejector pin is allowed to operate after the N-th operation set, so that the thermoplastic resin 80 can be easily stacked.

In addition, according to the injection molding method according to the embodiment, when the thermoplastic resin 80 is molded into the thick-walled component by stacking the thermoplastic resin 80 by performing the operation set including the filling and pressure holding process and the cooling and solidifying process multiple times, it is possible to prevent the occurrence of the sink marks and the voids. In addition, in the cooling and solidifying process, the occurrence of the sink marks and the voids can be further prevented by decreasing the distance between the cavity 20 and the core 30 and cooling and solidifying the filled thermoplastic resin 80 while pressurizing the filled thermoplastic resin 80.

In the injection molding apparatus and the injection molding method according to the embodiments, the thick-walled component 90 is molded by stacking the thermoplastic resin 80. Therefore, the thick-walled component (molded product) 90 molded by the injection molding apparatus or the injection molding method according to the embodiments has, for example, a multilayer structure of the thermoplastic resin 80. For example, when a cross section of the thick-walled component (molded product) is observed and the thermoplastic resin has a multilayer structure, it can be determined that the thick-walled component is a thick-walled component (molded product) molded by the injection molding apparatus or the injection molding method according to the embodiments.

In the injection molding apparatus and the injection molding method according to the embodiments, the filled thermoplastic resin 80 is cooled and solidified while being pressurized. Therefore, the thick-walled component (molded product) 90 molded by the injection molding apparatus or the injection molding method according to the embodiments has a higher density than that of, for example, a case where the filled thermoplastic resin 80 is cooled and solidified without being pressurized. Alternatively, the thick-walled component (molded product) 90 molded by the injection molding apparatus or the injection molding method according to the embodiments has a larger weight than that of, for example, a case where the filled thermoplastic resin 80 is cooled and solidified without being pressurized. For example, when the density is higher or the weight is larger than that of a case where the filled thermoplastic resin is cooled and solidified without being pressurized, it can be determined that the thick-walled component is the thick-walled component (molded product) molded by the injection molding apparatus or the injection molding method according to the embodiments.

As described above, according to the embodiments, provided are an injection molding apparatus and an injection molding method that can prevent occurrence of sink marks and voids when a thermoplastic resin is molded into a thick-walled component.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An injection molding apparatus configured to mold a thermoplastic resin into a thick-walled component by injection molding, the injection molding apparatus comprising:
a mold having a cavity and a core; and
a controller configured to control an operation of the mold,
the controller being capable of performing a filling and pressure holding process of filling the thermoplastic resin between the cavity and the core in a state in which a distance between the cavity and the core is increased, and a cooling and solidifying process of cooling and solidifying the filled thermoplastic resin while pressurizing the filled thermoplastic resin by decreasing the distance between the cavity and the core, and
the controller stacking the thermoplastic resin by performing an operation set including the filling and pressure holding process and the cooling and solidifying process a plurality of times.

2. The apparatus according to claim 1, wherein
the cavity includes a first contact member provided with a groove on a surface in contact with the thermoplastic resin.

3. The apparatus according to claim 2, wherein
the cavity further includes a second contact member provided with no groove on a surface in contact with the thermoplastic resin,
the controller performs the operation set N times (N is an integer of 2 or more),
the first contact member is used in first to (N−1)-th operation sets, and
the second contact member is used in an N-th operation set.

4. The apparatus according to claim 1, wherein
the cavity includes a first contact member whose surface in contact with the thermoplastic resin is heated to a temperature higher than that of the core.

5. The apparatus according to claim 4, wherein
the cavity further includes a second contact member whose surface in contact with the thermoplastic resin is heated to a temperature lower than that of the first contact member,
the controller performs the operation set N times (N is an integer of 2 or more),
the first contact member is used in first to (N−1)-th operation sets, and
the second contact member is used in an N-th operation set.

6. The apparatus according to claim 1, wherein
the mold further includes an ejector pin that is provided in the core and causes the solidified thermoplastic resin to protrude toward a cavity side,
the controller performs the operation set N times (N is an integer of 2 or more),
the ejector pin is not allowed to operate during first to N-th operation sets, and
the ejector pin is allowed to operate after the N-th operation set.

7. An injection molding method for molding a thermoplastic resin into a thick-walled component by injection molding that uses a mold having a cavity and a core, the injection molding method comprising:
a filling and pressure holding process of filling the thermoplastic resin between the cavity and the core in a state in which a distance between the cavity and the core is increased; and
a cooling and solidifying process of cooling and solidifying the filled thermoplastic resin while pressurizing the filled thermoplastic resin by decreasing the distance between the cavity and the core,
the thermoplastic resin being stacked by performing an operation set including the filling and pressure holding process and the cooling and solidifying process a plurality of times.
